(19) United States
(12) Patent Application Publication
(10) Pub. No.: US 2015/0341472 A1
(43) Pub. Date: Nov. 26, 2015

(54) System for real-time, graphics-based web communication using HTML 5 WebSockets

(71) Applicants: Jason Russell Yanofski, West Orange, NJ (US); Jason Matthew Dwyer, Whippany, NJ (US)

(72) Inventors: Jason Russell Yanofski, West Orange, NJ (US); Jason Matthew Dwyer, Whippany, NJ (US)

(73) Assignee: Jason Russell Yanofski, West Orange, NJ (US)

(21) Appl. No.: 14/282,130

(22) Filed: May 20, 2014

(51) Int. Cl. H04L 29/06; H04L 12/58; H04L 29/08

(52) U.S. Cl. CPC H04L 69/162; H04L 67/42; H04L 67/02; H04L 51/04

(57) ABSTRACT

A system for web-based graphical communication using HTML 5 WebSockets is described. The method enables multiple users to interact in a web-based environment by tracking and representing, in real-time, each other's messages, location, status, graphics and other gestures of communication.

### BACKGROUND OF THE INVENTION

Internet-based technologies comprise a major platform for person-to-person communication. Applications including email, blogs, message boards, instant messaging, mobile messaging, chat rooms, audio and video telephony are well represented in the prior art. Of these, email, instant messaging, blogs, message boards, web-based chat rooms and mobile application messaging rely on HTTP web servers to store and/or transmit communicated data to clients. In these cases, communication relies on the HTTP protocol and only allows unidirectional communication. FIG. 1 depicts a typical instance of HTTP web server-based communication. In this instance, client 101 transmits data through connection 103 to HTTP web server 110, which stores the transmitted data. Client 102 sends HTTP request 104 to the web server 110, which transmits data from client 101 to client 102 through connection 105. Connections between clients and the web server can be hard-wired or wireless. While current HTTP methods are sufficient for communication platforms that would not benefit from faster communication (i.e. email or message boards), there exists a need for real-time communication platforms that provide immediate relay of data. Despite this need, the unidirectional nature of HTTP requests represents a significant obstacle, limiting real-time communication between clients. Techniques, such as long polling, have been employed to circumvent these limitations of HTTP methods. Long polling is the process of configuring a client computer to rapidly send HTTP requests to retrieve new data when it becomes available to the server, allowing a typical HTTP server to emulate duplex server-client connections. A lack of true duplex connections between clients largely limits prior art communications to text and static imaged-based interactions. This limited interaction capability of prior art communication largely prevents the representation of complex emotions and behaviors, which comprise a large portion of human communication behavior. Some attempts to recapitulate emotions into text-based chat include the use of emoticons. Emoticons are graphical representations of emotions which rely on punctuation (i.e. a smiley face using a “:)” punctuation).

Voice and video telephony allow duplex communication. However, this is achieved through software installed on the client computer to allow communication using TCP/IP protocols, such as used by Skype. Given that these methods allow real-time video feeds between clients, emotional communication between users can be achieved much as it is in real life. Duplex communication can also be achieved by web browser-based software plug-ins, such as Adobe Flash or Microsoft Silverlight. These technologies use proprietary software, which is not universally supported by all web browsers and/or mobile and tablet devices, thus limiting their utility.

The HTML 5 WebSockets API allows duplex communication between client web browsers. In the prior art, WebSockets have been proposed for gaming and text-based messaging purposes. Neither of these approaches make use of the real-time duplex communication enabled by the WebSockets API to allow for a graphics-based communication platform, which would offer a richer communication experience to users.

There exists a need for a method of communication that provides users with a real-time, interactive, graphics-based chat environment using HTML 5 WebSockets.

### BRIEF SUMMARY OF THE INVENTION

The present invention provides a method to allow an improved real-time, interactive, expressive communication environment to one or more users using HTML 5 WebSockets. As used herein, “expressive” means any expression of communication or emotion between users.

### BRIEF DESCRIPTION OF THE DRAWINGS

FIG. 1 is a schematic diagram of a typical prior art communication between two example clients through a typical HTTP web server.

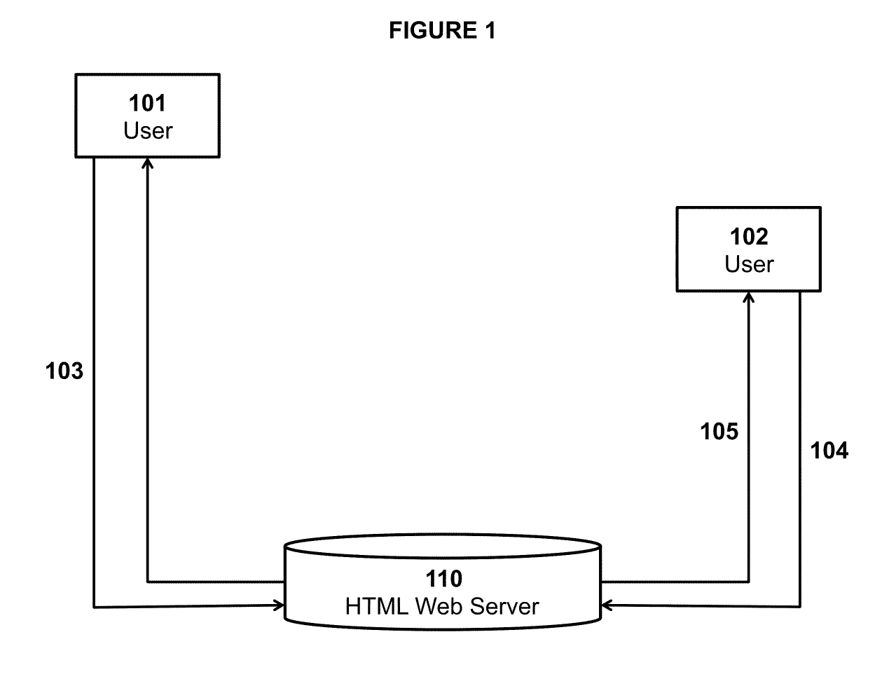

FIG. 2 is a schematic diagram of a communication environment using two example clients connected to both a typical HTTP web server and a WebSockets server.

FIG. 3 is a schematic diagram depicting an example user client view when inviting another user to communicate.

FIG. 4 is a schematic diagram depicting two example users interacting within a unique chat universe.

FIG. 5 is a schematic diagram depicting a chat room lobby populated with example public chat environments accessible by all users.

### DETAILED DESCRIPTION OF THE INVENTION

Methods and systems for implementing real-time, graphics-based communication are now described in various embodiments.

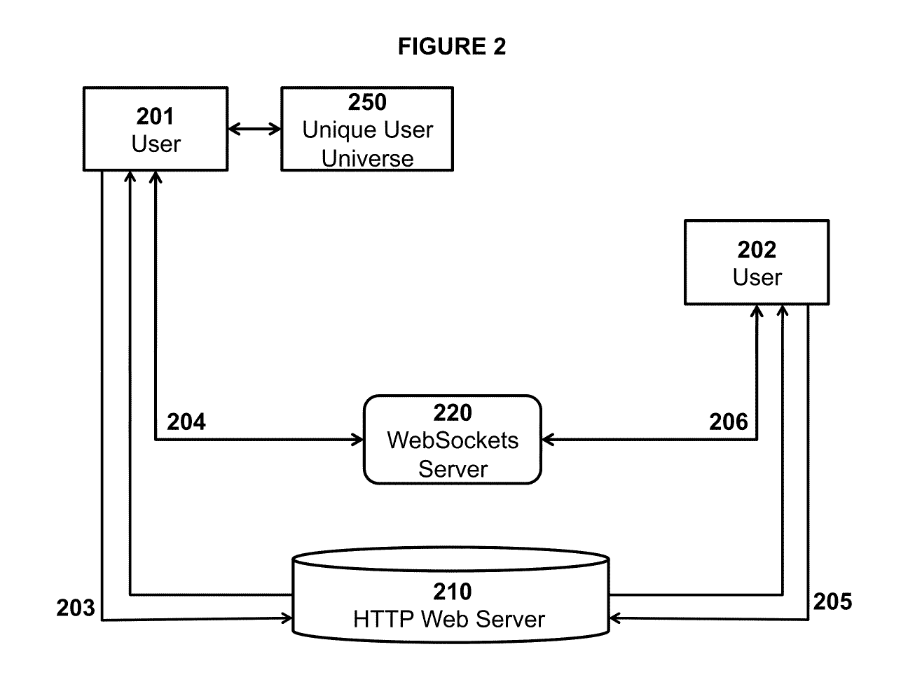

FIG. 2 depicts example software HTTP web server 210 running on a hardware server. Web server 210 comprises a software web server, such as Node, which can optionally store data in a relational or non-relational database.

Example user 201 is a user of a computer device with network connectivity, such as a desktop computer, laptop computer, tablet, or mobile device. User 201 is connected to web server 210 through connection 203, which can be hard-wired or wireless. User 201 is also connected to HTML 5 WebSockets server 220, which is compliant with the WebSockets API, through connection 204. Example user 202 is also connected to HTTP web server 210 through connection 205 and to WebSockets server 220 through connection 206.

User 201 enters a website hosted by web server 210 using a web browser, which is compliant with the HTML 5 WebSockets API, such as Firefox, Chrome, Internet Explorer or Safari. User 201 creates a user account providing a unique username and password. Web server 210 optionally stores user information including, but not limited to, user name, password, user-created avatar and/or other user preferences. User 201 initiates a communication session by entering unique user universe 250, which provides an empty window capable of rendering graphical content. As used herein, “universe” refers to any web browser window, frame or other screen capable of rendering graphic content. User 201 can customize universe 250 by altering background images. Additionally, user 201 can optionally generate a customized avatar using a graphics editor provided by the website or by using avatar images imported from other sources. After creation, the user 201 avatar is rendered within universe 250. Once rendered, user 201 can alter position within universe 250. User 201 can also interact with universe 250 by optionally typing messages, performing actions, presenting website hyperlinks, rendering audio content, delivering or directing to new web content, rendering video content, or in any way altering graphical content, all of which are rendered within universe 250. Actions can include, but are not limited to, gestures of communication and/or emotions, such as punching, kissing, pushing, shooting, throwing or any other display of communication behavior. Users may optionally interact with the chat environment to alter the location and actions of the user avatar, such as dragging icons with their mouse, typing messages or initiating preset animation graphics defined by the website or by the user. The user can have creative control over the way they interact within the universe and with other users. For example, when rendering a text communication, users may choose how the text is rendered (i.e. within a speech bubble or on a sign held up by their avatar). Users may optionally choose to render icon props into the universe environment (i.e. a graphic ball image) to further enhance the communication experience. For example, users could bounce the ball between them and perform game-like interactions. Anytime any user of the universe changes state information of the universe, these changes are immediately broadcasted to other users and reflected in the universe window. Universe 250 may optionally provide a physics environment to facilitate interaction of graphical icons and communication gestures. All graphics capabilities including icon props, communication gesture animations and avatar/universe interactions can be user defined or defined by the hosting website. All data relevant to universe 250 is optionally stored in a software database accessible to web server 210.

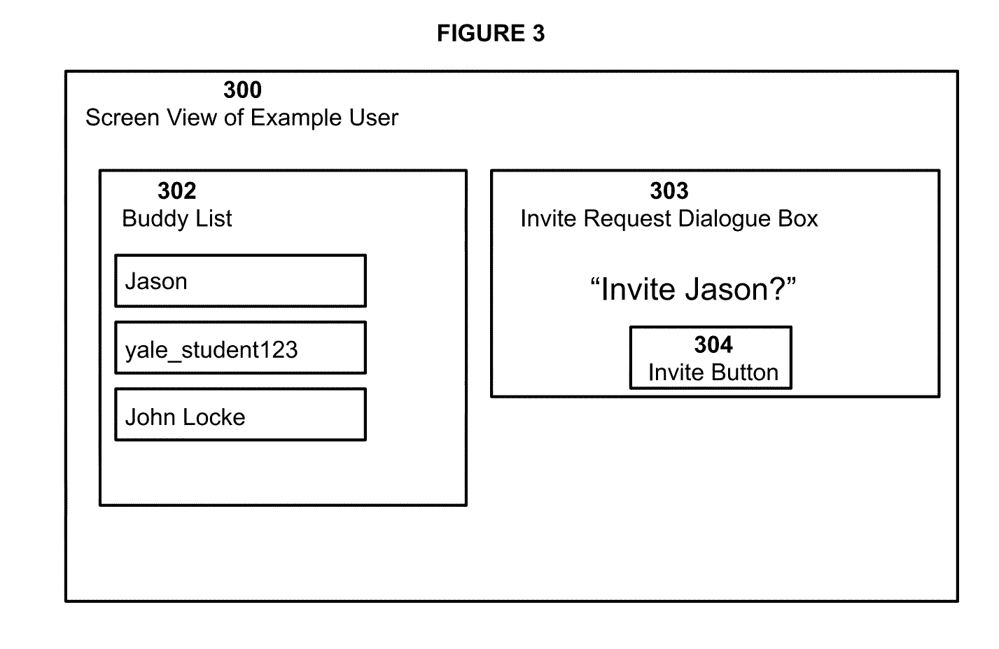

To initiate a communication session with additional user 202, user 201 can choose to invite user 202 to enter the custom universe of user 201 as depicted in FIG. 3. User 202 can optionally choose to deny the request of user 201 or agree to join the universe of user 201. In the case of user 202 agreeing to join universe 250, a duplex WebSockets connection is simulated between user 201 and user 202 in that both users become “subscribed” to receive changes broadcasted by the other user. User 202 is rendered within universe 250 and presented with the graphical content of universe 250 on the client computer controlled by user 202. Universe 250 is capable of hosting a plurality of users. Data relating graphical information about each user is then broadcast to all clients connected to universe 250 in real-time. The aforementioned graphical information includes, but is not limited to, position, gestures of communication, actions, text communication, audio communication or video communication.

FIG. 3 depicts an example screen view of example user 300, in which a web server populates buddy list 302 of an example user. “Buddy” means any other user identified as being a friend, having a personal relationship, or any other connection to user 300. The user chooses to invite an example buddy named “Jason” to join the user 300 universe. User 300 is then presented with dialogue box 303 to initiate the invite request to Jason. User 300 clicks invite button 304 and the invite request is sent to Jason.

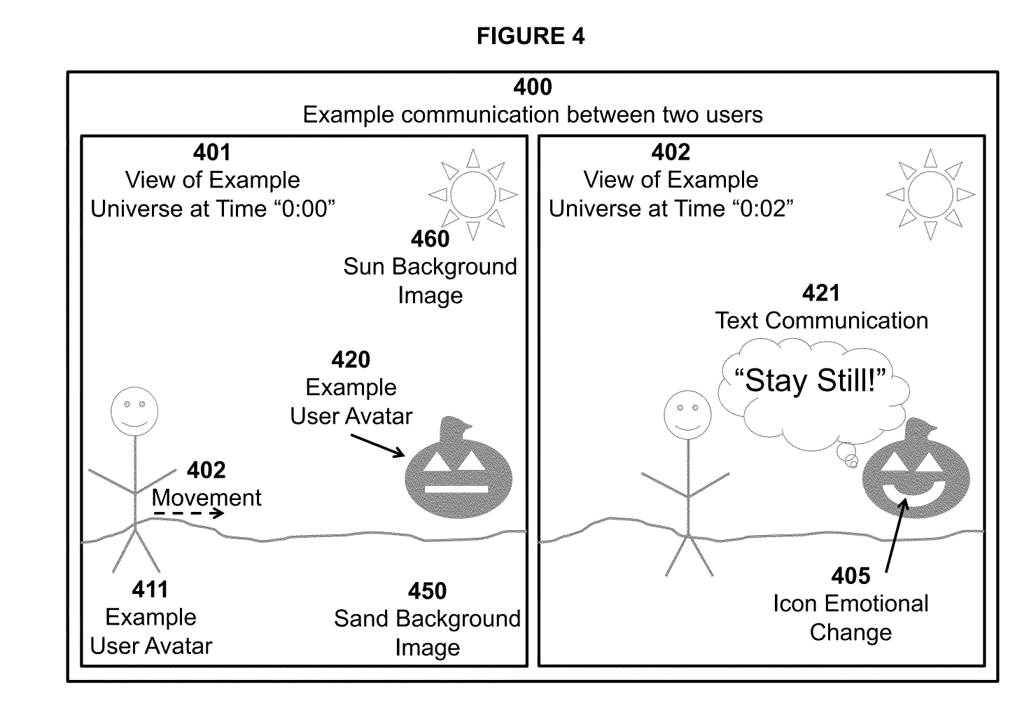

FIG. 4 depicts an example interaction between two example users. 400 depicts a view seen identically on the client computers controlled by a first example user and a second example user. View 401 represents an example universe environment designed by the first user. View 401 is shown at an example time point “0:00.” In this example, the first user has chosen to design a custom background image of a beach scene with sand 450 and sun 460. The first user controls user-defined avatar 411. In one example, the first user initiates directional movement 402 of user avatar 411, which is rendered in real-time to all users connected through WebSockets connections to the example universe (i.e. the first and second example users). View 402 represents a view of the same universe depicted two seconds later (i.e. at time point “0:02”). In this example, the second user controls user avatar 420 that consists of a “jack-o-lantern” icon. The positional change initiated by the first user is displayed within the universe view, which is provided in real-time to all users hosted within the universe. When user avatar 411 makes a positional change, this change is represented on the client computer of both the first and second example users. In response to the positional change by the first user, the second user enters example text communication 421, which is likewise displayed to all users of the universe. Additionally, the second user initiates icon emotional change 405 in user avatar 420, which changes the emotional expression of the user 420 avatar (i.e. a smile indicating happiness). All state information is transmitted to all users of the universe in real time. Users can choose to leave the universe environment at any time at the user's discretion. The aforementioned example of user-defined graphics (i.e. a beach scene or a jack-o-lantern avatar) are given as examples and are not meant to limit the scope of what can be considered “graphical” content. For example, graphical user avatars could be images imported from photographs, drawn by the user or sourced from any other images or altered in any other way by the user.

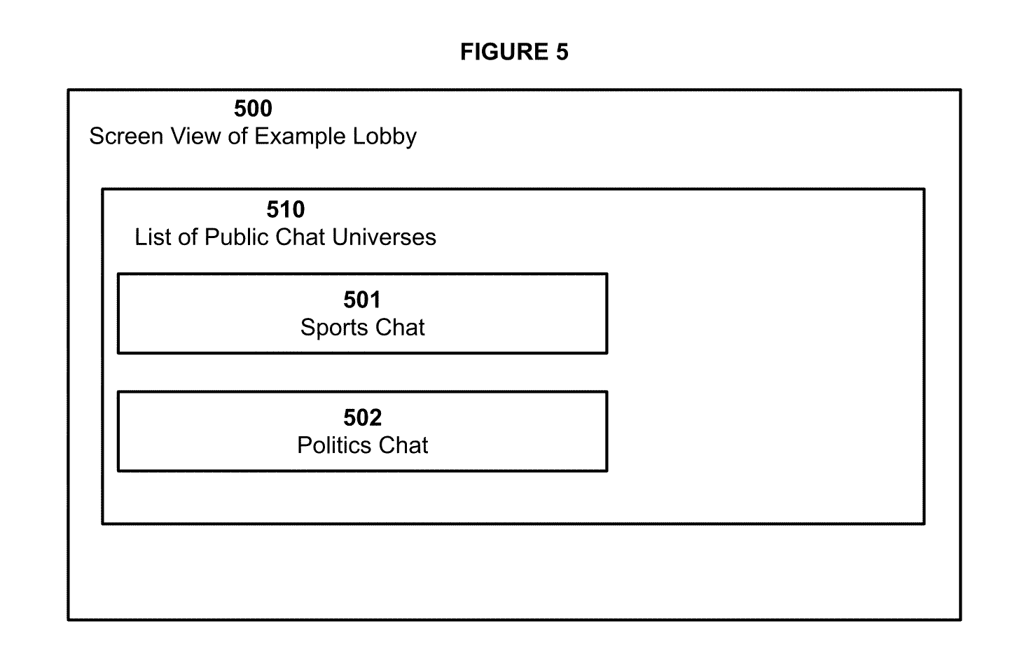

In another embodiment, a website hosted by a web server is configured to populate a lobby webpage with a list of available interest-specific universe environments. FIG. 5 depicts example lobby webpage 500, which presents a list of public chat universes 510 to facilitate communication about two example topics: sports 501 and politics 502. Users can choose to enter these public “chat room” universes to experience graphical interactions with other users.

The aforementioned embodiments and figures are provided by way of example, and are not meant to limit the scope or use of the present invention in any way.

1. A system for providing real-time, graphics-based web communication consisting of:
an HTTP web server, which can access a relational or non-relational database,
an HTML 5 WebSockets server,
a first client computer capable of connecting to the HTTP web server through a first web server connection, and capable of connection to the WebSockets server through a first WebSockets connection,
a second client computer capable of connecting to the HTTP web server through a second web server connection, and capable of connection to the WebSockets server through a second WebSockets connection;
wherein the first and second client computers are capable of storing and transmitting data;
wherein the first and second client computers are configured to be capable of rendering graphical content, controlling movement of graphical content, and controlling gestures of emotion and communication by graphical icons;
wherein the first and second client computers are configured to be capable of broadcasting state information to the HTTP web server and to the WebSockets server;
wherein the first and second client computers are configured to be capable of sending, and responding to, communication requests;
wherein the database is capable of storing data provided by connected client computers and transmitting data to connected client computers;
and wherein the WebSockets server is capable of real-time broadcasting of client state information to other client computers connected to the same WebSockets server.

2. The system of claim 1, wherein state information includes:
graphical icons,
coordinate location of graphical icons,
text communication,
animations,
audio content,
video content,
gestures of communication,
and gestures of emotion.

3. The system of claim 1, wherein a client computer is one of the following:
a desktop computer,
a laptop computer,
a tablet computer,
or a mobile device.
